(19) United States
(12) Patent Application Publication
(10) Pub. No.: US 2022/0237172 A1
(43) Pub. Date: Jul. 28, 2022

(54) Techniques and Architectures for Providing Transactional Stateful Data Protection Deletion Functionality

(71) Applicant: salesforce.com, inc., San Francisco, CA (US)

(72) Inventors: Heng Zhang, San Jose, CA (US); Kevin Terusaki, Oakland, CA (US); Zhidong Ke, Milpitas, CA (US); Utsavi Benani, Fremont, CA (US); Mugdha Choudhari, San Carlos, CA (US)

(21) Appl. No.: 17/156,442

(22) Filed: Jan. 22, 2021

(51) Int. Cl. G06F 16/23; G06F 16/22; G06F 21/62

(52) U.S. Cl. CPC G06F 16/2358; G06F 16/2365; G06F 21/6245; G06F 16/2282; G06F 16/2329

(57) ABSTRACT

Techniques and mechanisms to manage deletions from data tables are disclosed. A request to delete data from at least one data table in an environment having tables storing data from multiple disparate sources is received. The environment can also have a delete request status table and a notification table. Processing of the delete request is managed utilizing a multi-stage workflow where stages of the multistage workflow are tracked by updating entries to the delete request status table. Completion of the delete request is verified by checking at least one entry in the delete request status table corresponding to the delete request. A corresponding entry is written to the notification table in response to a successful verified completion of the delete request.

### TECHNICAL FIELD

Embodiments relate to techniques for managing data traffic including deletion of data in complex environments such as, for example, data lake environments. More particularly, embodiments relate to stateful deletion of data in complex environment that support various data privacy requirements, for example, General Data Protection Regulation (GDPR) requirements.

### BACKGROUND

A “data lake” is a collection data from multiple sources and is not stored in a standardized format. Because of this, collection of the data in the data lake is not as systematic and predictable as more structured collections of data. Thus, many of the tools that are utilized to ingest data into a data lake (or other data collection structures) do not (or cannot) provide atomic writes to the final data source.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of an architecture to provide atomic transactions across multiple data sources.

FIG. 2 is a flow diagram of one embodiment of a technique for managing data deletions in a data lake environment.

FIG. 3 illustrates a set of jobs that can interact to provide a technique for managing data deletions in a data lake environment.

FIG. 4 is a flow diagram of an example embodiment of a technique to provide atomic deletion functionality in a data lake environment.

FIG. 5 is a block diagram of one embodiment of a processing resource and a machine readable medium encoded with example instructions to provide atomic deletions across multiple data sources.

FIG. 6 illustrates a block diagram of an environment where an on-demand database service might be used.

FIG. 7 illustrates a block diagram of an environment where an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

In general, a data lake is a data repository that stores data in its native format until the data is needed. Typically, these data repositories are very large and ingest constant (or near constant) data streams for multiple sources. The term “data lake” refers to the strategy of gathering large amounts of natively-formatted data and not to any particular mechanisms for maintaining the repository. Thus, the mechanisms described herein are described as certain embodiments with respect to various components and data flow elements; however, the techniques are more broadly applicable and could be used with other components or in other environments.

Some data lake implementations are based on Apache Hadoop, which provides various software utilities that provide distributed processing of large data sets across multiple computing devices. Other data lake implementations can be based on Apache Spark, which provides a framework for real time data analytics using distributed computing resources. Other platforms and mechanisms can be utilized to manage data lakes (or other large collections of data).

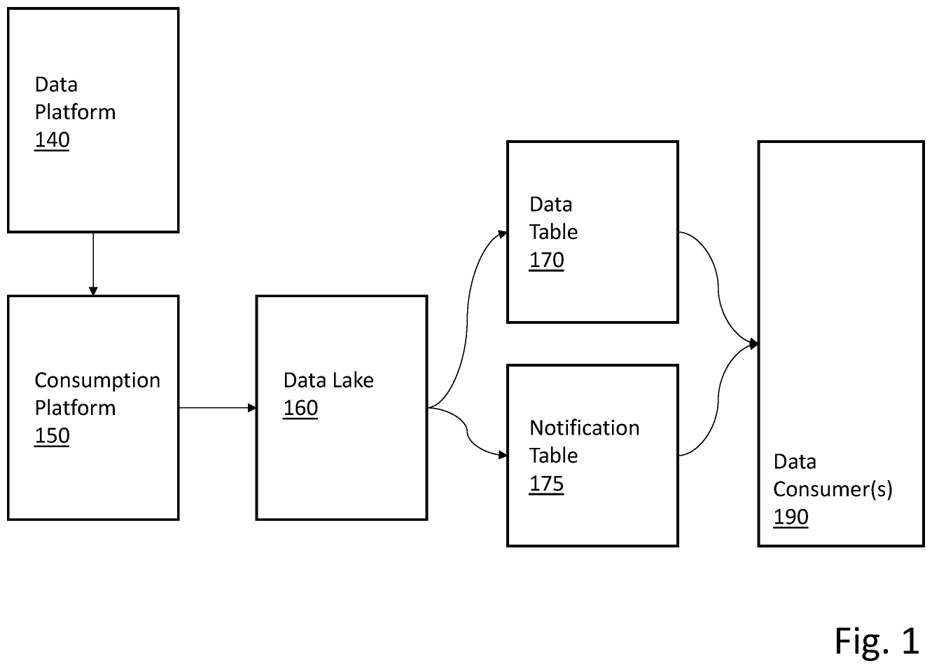

FIG. 1 is a block diagram of an architecture to provide atomic transactions across multiple data sources. The block diagram of FIG. 1 provides an ingestion mechanism that can be utilized to provide data to a data lake (or other collection of data). The mechanism of FIG. 1 provides a level of atomicity for ingestions transactions for a data lake or similar data repository.

Data platform 140 can provide a structure for handling large data loads. For example, in some embodiments, data platform 140 can be provided utilizing Apache Kafka (or similar architecture). Apache Kafka is an open source platform available from Apache Software Foundation based in Wakefield, Mass., USA. Other stream processing and/or message broker platforms can be utilized in different embodiments.

Continuing with the Kafka example, Kafka provides a unified, high-throughput, low-latency platform for handling real-time data feeds. Kafka is based on a commit log concept and allows data consumers to subscribe to data feeds to be utilized by the consumer, and can support real-time applications. In operation, Kafka stores key-value messages from any number of producers, and the data can be partitioned into topic partitions that are independently ordered. Consumers can read messages from subscribed topics.

Data platform 140 functions to gather various types of raw data from any number of data sources (not illustrated in FIG. 1). These data sources can include, for example, data received via graphical user interfaces (GUIs), location data (e.g., global positioning system (GPS) data), biometric data, etc. Any type of data from any number of disparate data sources can provide data to be gathered via data platform 140.

Consumption platform 150 can provide a mechanism to consume data from data platform 140 and manage ingestion of the data to data lake 160. In some embodiments, consumption platform 150 is a distributed cluster-computing framework that can provide data parallelism and fault tolerance. For example, in some embodiments, consumption platform 150 can be provided utilizing Apache Spark (or similar architecture). Apache Spark is an open source platform available from Apache Software Foundation based in Wakefield, Mass., USA. Other consumption platforms and/or data management mechanisms can be utilized in different embodiments.

Continuing with the Spark example, Spark provides an open source distributed general purpose cluster computing framework with an interface for programming clusters with parallelism and fault tolerance. Spark can be used for streaming of data from data platform 140 to data lake 160. Thus, in various embodiments, large numbers of parallel Spark jobs can be utilized to ingest data to data lake 160.

Data lake 160 functions to store data acquired via data platform 140 and managed/routed by consumption platform 150. As described in greater detail below, the processing pipeline for data lake 160 can provide atomic transactions across multiple data sources. In various embodiments, data ingestion can be provided by parallel streaming jobs (e.g., Spark streaming jobs) that can function to consume data in real time (or near real time) and write the data to two data sources (e.g., data table 170 and notification table 175) in a single transaction. Any number of similar parallel structures can be supported. This can provide atomic transactions between data lake 160 and data consumers 190

In one embodiment, in order to provide transactions with a data table, the following four scenarios are supported: 1) writes to both data table 170 and notification table 175 are successful; 2) the write to data table 170 is successful and the write to notification table 175 is unsuccessful; 3) the write to data table 170 is unsuccessful an the write to notification table 175 is successful; and 4) the writes to both data table 170 and notification table 175 are unsuccessful.

In a Spark-based embodiment, for example, the open source Delta application program interface (API) can be utilized to provide a version for a given operation. In some embodiments (also Spark-based) the foreachBatch API can be utilized to group writes into batch operations. In alternate embodiments, other APIs/interfaces can be utilized to provide similar functionality. In some embodiments, the write to data table 170 is attempted before the write to notification table 175.

In general, data consumer(s) 190 is/are notified that data is available after both data table 170 and notification table 175 are written to successfully. Data consumer(s) 190 can be any type of data consumer, for example, analytics platforms, data warehouses, artificial intelligence (AI) platforms, etc.

Thus, the architecture of FIG. 1 can provide gathering/ingestion of various types of data from any number of supported data sources utilizing data table-notification table pairs to support atomic transactions from the various data sources to one or more data consumers (190).

While the description of FIG. 1 illustrates the general concept of ingestion and consumption within a data lake environment, deletion of data within the data lake environment must also be handled properly. In some situations this involves following relevant governmental regulations, for example, General Data Protection Regulation (GDPR) requirements within the European Union (EU). The EU is but one example, other jurisdictions including, for example, Japan, Brazil, South Korea and Kenya have similar requirements. In various embodiments, a functionality is provided to delete specific data in the data lake to satisfy GDPR (or similar) requirements.

For example, GDPR requirement in the EU, controllers and processors of personal data must provide safeguards to protect data (e.g., pseudonymization, full anonymization). For example, data controllers must provide the highest-possible privacy settings by default so that the datasets are not publicly available by default and cannot be used to identify a subject. No personal data may be processed unless this processing is done under one of the six lawful bases specified by the regulation (i.e., consent, contract, public task, vital interest, legitimate interest or legal requirement). When the processing is based on consent the data subject has the right to revoke it at any time.

Further, in the EU, for example, data controllers must clearly disclose any data collection, declare the lawful basis and purpose for data processing, and state how long data is being retained and if it is being shared with any third parties or outside of the EEA. Firms have the obligation to protect data of employees and consumers to the degree where only the necessary data is extracted with minimum interference with data privacy from employees, consumers, or third parties. Firms should have internal controls and regulations for various departments such as audit, internal controls, and operations. Data subjects have the right to request a portable copy of the data collected by a controller in a common format, and the right to have their data erased under certain circumstances.

Requests can vary from organization, user and data subject level for data deletion. In various embodiments described herein, one or more of the following characteristics can be supported: 1) performing automatic deletion on data subjects; 2) tracking the progress of a GDPR request; and/or 3) reporting the status of execution for the GDPR result to, for example, internal auditing systems.

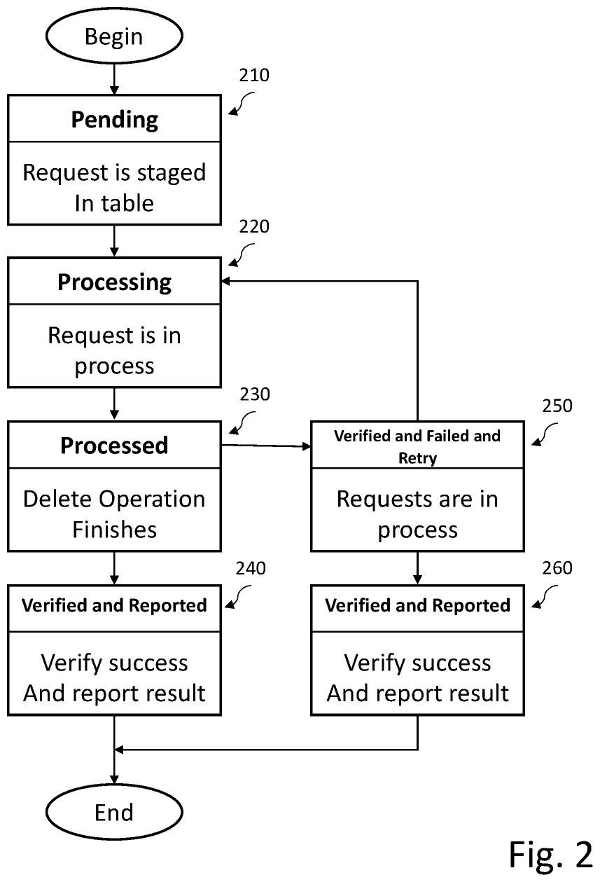

In the example of FIG. 2, the following request lifecycle stages can be provided for a delete request. A “pending” stage is one in which a request is waiting to be processed. A “processing” stage is one in which the request is in process. A “processed” stage is one in which the request has been processed. A “Verified and Reported” stage is one in which a request has been verified and the result has been reported. A “Verification Failed and Retry” stage is one in which verification has failed and a retry request has been sent. A “Failed and Reported” stage is one in which the maximum number of retries has been reached, the retry sequence has failed and the result has been reported. In alternate embodiments, additional and/or different stages can be utilized.

FIG. 2 is a flow diagram of one embodiment of a technique for managing data deletions in a data lake environment. As described in the examples that follow, the stages of the flow diagram can be utilized to accomplish four workflows: 1) a stage request; 2) a deletion; 3) verify of a deletion and retry; and 4) result report. Additionally, and update to the notification table of the delete count can also be supported.

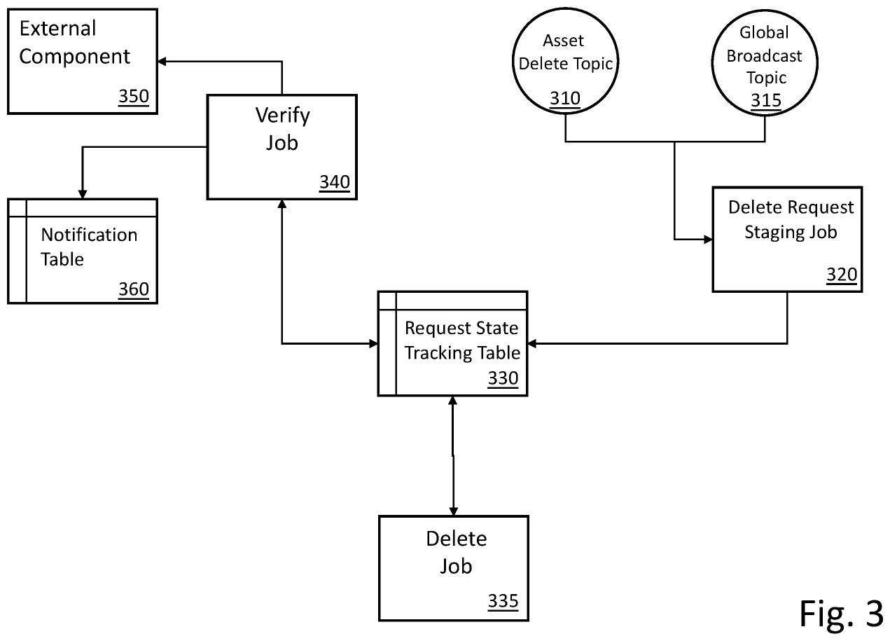

In various embodiments, the workflows of FIG. 2 can be provided within an environment such as, for example, the embodiment illustrated in FIG. 3 to provide stateful data protection deletion functionality. Thus, utilizing a delta table in a data lake, data deletion requests that comply with relevant regulations (e.g., GDPR) can be provided. Further, in some embodiments, transactional atomic deletion can be provided.

In one embodiment, in pending stage 210, a delete request can be staged in a delta table, for example. In some embodiments utilizing Amazon Web Services (AWS), the Delta Table AWS S3 location can be scoped with a namespace identifier. In processing stage 210 a delete request is waiting to be processed.

In one embodiment, in processing stage 220, the delete request is being processed. This can include, for example, reading from one or more relevant topics, providing tracking information, performing updates and/or related queries. Various embodiments for processing the delete request are provided below with respect to FIG. 3.

In one embodiment, when the processing completes in stage 220, the flow moves to processed stage 230 where the delete operation finishes. The delete request can be verified and, if the verification is successful, in stage 240, the success can be reported. If the verification is not successful, in stage 250, the process can be retired a specified number of times (e.g., 5, 10, 25). If verification fails after the specified number of retries, in stage 250, a failure result can be reported in stage 260.

FIG. 3 illustrates a set of jobs that can interact to provide a technique for managing data deletions in a data lake environment. In the example embodiment three jobs (delete request staging job 320, delete job 335, verify job 340) can be utilized to manage deletion of data according to relevant regulations (e.g., GDPR).

The jobs illustrated in FIG. 3 can be, for example, Spark jobs that read from one or more Kafka (or similar) topics. In the specific example of FIG. 3, delete request staging job 320 can read from asset delete topic 310 and global broadcast topic 315. In one embodiment, asset delete topic 310 . . . In one embodiment, global broadcast topic . . . Delete request staging job 320 functions to retrieve information from the one or more relevant topics to identify and stage delete requests corresponding to one or more tables in a data lake environment.

In one embodiment, in a multitenant environment having a data lake, org delete requests are sent to global broadcast topic 315 and user or data requests are sent to asset delete topic 310. Delete request staging job 320 monitors the topics and writes delete requests to request state tracking table 330. In one embodiment, when delete request staging job 320 writes a delete request to tracking table 330, the status of “Pending” is associated with the request.

Delete job 335 functions to process delete requests stored in table 330. Delete job 335 can also update the state of each job in table 330 indicating, for example, the stages described above in FIG. 2. In one embodiment delete job 335 represents a dedicated Spark job that can be triggered periodically (e.g., each hour, every 20 minutes, 5 or 10 times a day) by a scheduler to provide deletion functionary. The delete requests can correspond to orgs, users, data, tables, etc.

In one embodiment, when started delete job 335 can query request state tracking table 330 for all requests in a Pending state and change the state to Processing. When delete job 335 finishes one request, the finished request can be changed to the Processed state. In some embodiments, delete job 335 can split requests into sub-batches to manage workload.

Verify job 340 functions to verify completion of delete requests stored in table 330. In one embodiment verify job 340 represents a dedicated Spark job that can be triggered periodically (e.g., each hour, every 20 minutes, 5 or 10 times a day) by a scheduler to provide verification of deletion functionary. The delete requests can correspond to orgs, users, data, tables, etc.

In one embodiment, when started verify job 340 can query request state tracking table 330 for all requests in a Processed state or a VerificationFailedAndRetry state. In one embodiment, for each request verify job 340 can query rows by keys and expect an empty result. If the result is not empty and the request has not reached the maximum number of retries, verify job 340 can create a new request for retry and update the request state to VerificationFailedAndRetry and increase the retry count. Otherwise, verify job 340 can report the result and update the request state with FailedAndReport.

If the result is empty or the request has reached the maximum number of retires, verify job 340 can report the final result to external component 350 and update the state to VerifiedAndReported or to FailedAndReported.

In some embodiments, in order to provide an atomic delete transaction, notification table 360 can be utilized in association with a data table and/or external component 350. Various techniques for providing an atomic delete functionality are described in greater detail below.

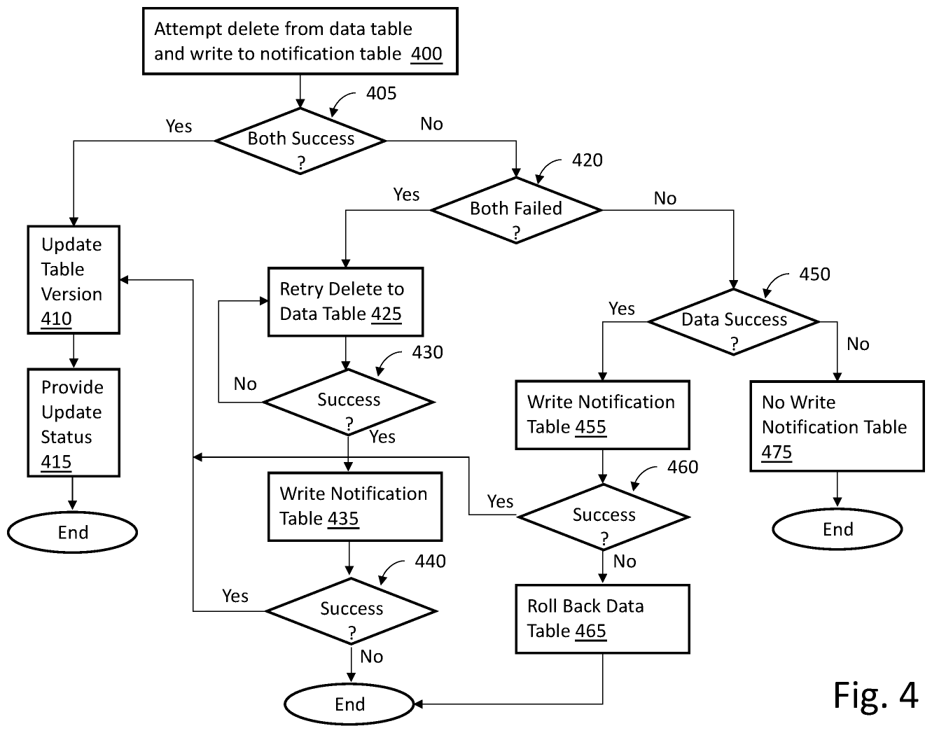

FIG. 4 is a flow diagram of an example embodiment of a technique to provide atomic deletion functionality in a data lake environment. The flow illustrated in FIG. 4 can be provided within the context of the architectures of FIG. 1-3.

The streaming job(s) attempt to write both to the state tracking table (e.g., 330) and to the notification table (e.g., 360), 400. As discussed above, this can be accomplished via a Spark jobs or similar mechanisms. In the example embodiment of FIG. 3, various streaming jobs, for example, delete request staging job 320, delete job 335 and verify job 340 write to, or modify entries in, request state tracking table 330 during the process of deleting the requested data. In some embodiments, the deletion process can be treated as an atomic transaction such that notification of completion of the process can be provided by verify job 340 and notification table 360.

If the deletion process and the write to the notification table are successful, 405, then the table version is updated, 410 and a status update or notification can be provided, 415, to allow one or more downstream data consumers (e.g., external component 350) to be informed of the successful deletion. In the example embodiment of FIG. 3, verify job 340 can determine if the delete request has been successfully handled and update notification table 360 accordingly. The delete operations as described with respect to FIGS. 2 and 3 can be treated as atomic transactions by using notification table 360 to indicate success or failure of a requested delete operation.

If both the delete operation and the write to the notification table are not successful, 405, because both the delete and the write to the notification table have failed, 420, then the delete operations is retried a pre-selected (e.g., 2, 10, 14, 37) number of times, 425 (e.g., as discussed above). If one of the retries is successful, 430, then another attempt can be made to write the notification table, 435. If the write to the notification table is successful, 440, then the table version is updated, 410 and a status update or notification can be provided, 415, to allow one or more downstream data consumers to be informed of the successful deletion. If the write to the notification table is not successful, 440, then the process can end.

If both the delete and the write to the notification table are not successful, 405, because one of the delete and the write to the notification table have failed, 420, then if the delete was successful, 450, the write to the notification table is retried, 455. In some embodiments, a pre-selected number of retries can be attempted before determining success or failure (e.g., 460). If the retried write to the notification table is successful, 460, then the table version is updated, 410 and a status update or notification can be provided, 415, to allow one or more downstream data consumers to be informed of the successful writes. If the retried write to the notification table is not successful, 460, then the table can be rolled back, 465, and the process can end.

If both the delete and the write to the notification table are not successful, 405, because one of the delete and the write to the notification table have failed, 420, then if the delete was not successful, 450, there is no write to the notification table, 475. The process can then end.

In summary, if both the data deletion and the corresponding write to a notification table are successful, the version of the data table (that stored the deleted data) is increased and the downstream data consumer(s) is/are notified via an update to the notification table. If the data deletion and a write to the notification table both fail, the delete operation can be retried because the deletion is attempted prior to the notification table write. If, after a pre-selected number of retries the delete process still fails the transaction can be terminated and no modifications occur to either the data table or the notification table for the current transaction. The table versions will be unchanged so the downstream consumers will have no indication of new data.

In some embodiments, if the data deletion is successful and the write to the notification table fails, the version of the data table is increased but the data table is rolled back to its previous state because the transaction cannot be completed due to the failure of the write to the notification table. No downstream consumer notification is provided. If the delete operation fails and the write to the notification table succeeds (or could succeed), the version of the data table is not increased and the data is not written to the notification table. No downstream consumer notification is provided.

Thus, only when the delete process and the notification table write are successful will the downstream data consumer be notified of the newly available data. Otherwise, the downstream data consumer will not see any changes. The result is the ability to provide an atomic delete transaction from the perspective of the downstream consumer within an environment in which data can be ingested from multiple disparate sources having different data formats.

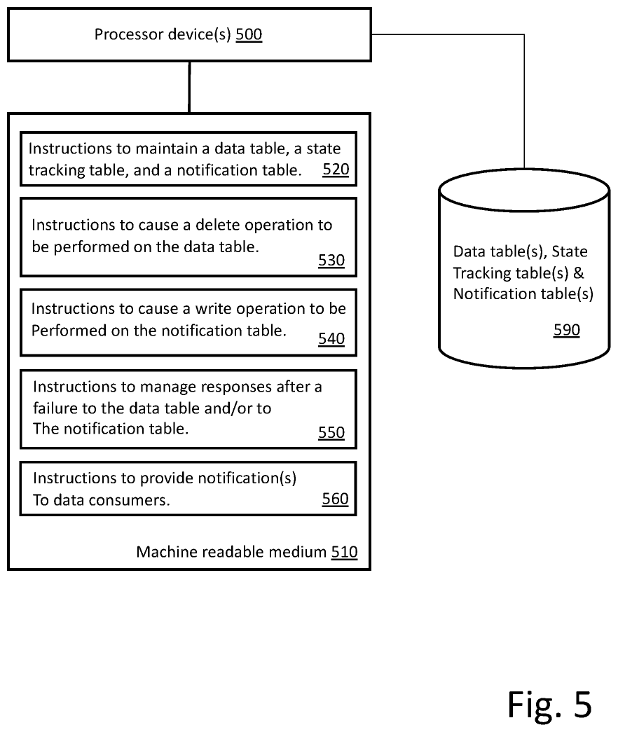

FIG. 5 is a block diagram of one embodiment of a processing resource and a machine readable medium encoded with example instructions to provide atomic deletions across multiple data sources. Machine readable medium 510 is non-transitory and is alternatively referred to as a non-transitory machine readable medium 510. In some examples, the machine readable medium 510 may be accessed by processor device(s) 500. Processor device(s) 500 and machine readable medium 510 may be included in computing nodes within a larger computing architecture.

Machine readable medium 510 may be encoded with example instructions 520, 530, 540, 550 and 560. Instructions 520, 530, 540, 550 and 560, when executed by the processor device(s) 500, may implement various aspects of the techniques for providing managed delete transactions as described herein.

In some embodiments, instructions 520 cause processor device(s) 500 to maintain the data table, the state tracking table and the notification table. The data table(s), state tracking table(s) and/or notification table(s) can be maintained on storage device(s) 590. As discussed above, multiple data tables, state tracking tables and/or notification tables can be maintained and utilized in parallel. In some embodiments, at least a portion of the data table, state tracking table and notification table functionality can be provided in association with open source components (e.g., KAFKA, SPARK). In other embodiments, instructions 520 can provide all of the table functionality. In some embodiments, the described functionality is provided within a multitenant on-demand services environment.

In some embodiments, instructions 530 cause the delete operation to be performed on the data table utilizing the state tracking table. As discussed above, the delete process can include multiple states that can be utilizing the state tracking table. Upon completion of the process, a write operation can be performed to the notification table, 540.

In some embodiments, instructions 550 cause processor device(s) 300 to manage responses after a failure to write to the data table and/or a failure to write to the notification table. As discussed above, various responses can be initiated in response to a write failure. Alternative embodiments can also be supported.

In some embodiments, instructions 560 cause processor device(s) 300 to maintain the data table and the notification table. As discussed above, in response to successful writes to both the data table and the notification table an update or other indication is provided to downstream (in the data ingestion stream) consumers to allow the consumers to act on the newly available data. In some embodiments, consumers may be notified that the data table and/or the notification table have been updated. In other embodiments, the consumers may periodically check the notification table to determine whether any updates have occurred. A combination can also be supported.

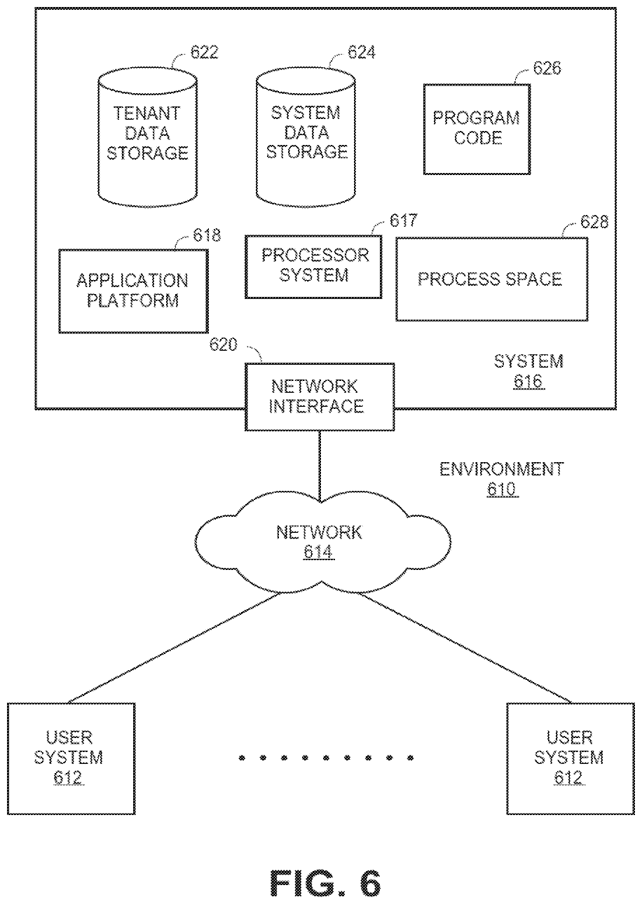

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

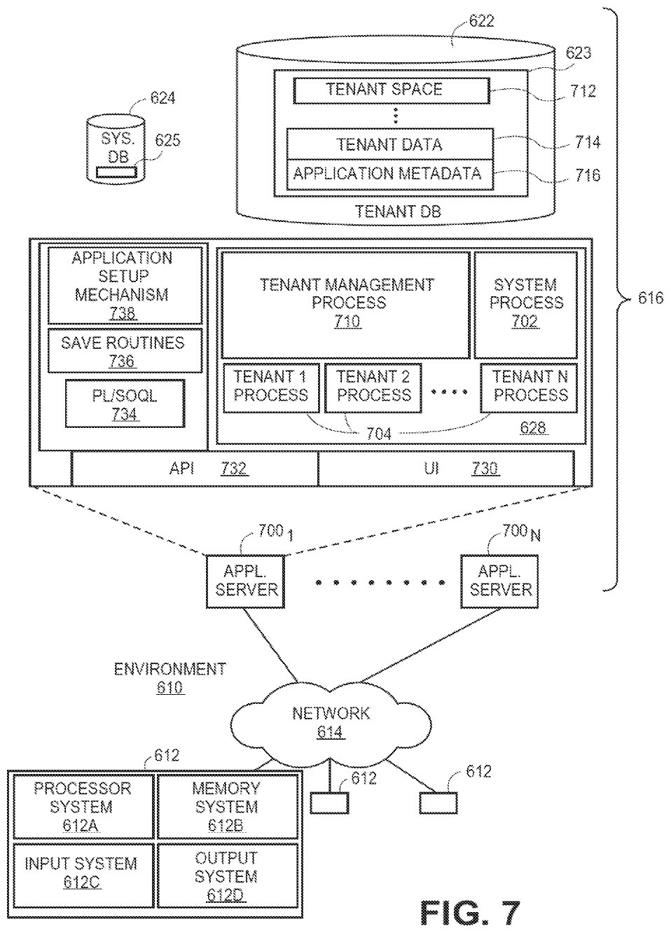

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. Each user system 612 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core series processor or the like. Similarly, system 616 (and additional instances of an MTS, where more than one is present) and all of their components might be operator configurable using application(s) including computer code to run using a central processing unit such as processor system 617, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 BIG-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method for deleting data, the method comprising:
receiving a delete request to delete data from at least one data table in an environment having tables storing data from multiple disparate sources, the environment having at least a delete request status table and a notification table;
managing processing of the delete request with a multi-stage workflow where stages of the multistage workflow are tracked by updating one or more entries of the delete request statics table;
verifying completion of the delete request by checking at least one entry in the delete request status table corresponding to the delete request;
attempting to write a corresponding entry to the notification table in response to a successful verified completion of the delete request; and
transmitting a notification according to a result of both verifying completion of the delete request and attempting to write the corresponding entry to the notification table.

2. The method of claim 1, wherein data subject to the delete request comprises personal data subject to data protection regulations.

3. The method of claim 1, further comprising:
retrying one or more stages of the delete request a pre-selected number of times or until the write to the corresponding entry in the notification table is successful; and
generating an indication of failure of the delete request in response to the pre-selected number of unsuccessful attempts.

4. The method of claim 1, further comprising:
rolling back an entry in the data table corresponding to the delete request in response to successful processing of the delete request and failure of the writing of the notification table entry.

5. The method of claim 1, further comprising:
managing multiple delete requests for multiple data tables that receive data from multiple disparate data sources concurrently; and
managing multiple corresponding notification tables.

6. The method of claim 1, further comprising modifying a version indicator for the notification table if the delete request is successfully processed and the write attempt to the notification table is successfully completed.

7. The method of claim 1, further comprising analyzing a version indicator corresponding to the notification table to determine if changes have been made to the notification table that indicate changes to the data table.

8. A non-transitory computer-readable medium having stored thereon instructions that, when executed by one or more processors, are configurable to cause the one or more processors to:
process a delete request to delete data from at least one data table in an environment having tables storing data from multiple disparate sources, the environment having at least a delete request status table and a notification table;
manage processing of the delete request with a multi-stage workflow where stages of the multistage workflow are tracked by updating one or more entries of the delete request status table;
verify completion of the delete request by checking at least one entry in the delete request status table corresponding to the delete request;
attempt to write a corresponding entry to the notification table in response to a successful verified completion of the delete request; and
transmit a notification according to a result of both verifying completion of the delete request and attempting to write the corresponding entry to the notification table.

9. The non-transitory computer-readable medium of claim 8, wherein data subject to the delete request comprises personal data subject to data protection regulations.

10. The non-transitory computer-readable medium of claim 8, further comprising instructions that, when executed by the one or more processors, are configurable to cause the one or more processors to:
retry one or more stages of the delete request a pre-selected number of times or until the write is successful; and
generate an indication of failure in response to the pre-selected number of unsuccessful attempts.

11. The non-transitory computer-readable medium of claim 8, further comprising rolling back a data table in response to successful processing of the delete request and failure of the writing of the notification table entry.

12. The non-transitory computer-readable medium of claim 8, further comprising:
managing multiple delete requests for multiple data tables that receive data from multiple disparate data sources concurrently; and
managing multiple corresponding notification tables.

13. The non-transitory computer-readable medium of claim 8, further comprising instructions that, when executed by the one or more processors, are configurable to cause the one or more processors to modify a version indicator for the notification table if the delete is successfully processed and the write attempt to the notification table is successfully completed.

14. The non-transitory computer-readable medium of claim 8, further comprising instructions that, when executed by the one or more processors, are configurable to cause the one or more processors to analyze a version indicator corresponding to the notification table to determine if changes have been made to the notification table that indicate changes to the data table.

15. A system comprising:
a memory system;
one or more hardware processors coupled with the memory system, the one or more hardware processors configurable to:
process a delete request to delete data from at least one data table in an environment having tables storing data from multiple disparate sources, the environment having at least a delete request status table and a notification table;
manage processing of the delete request with a multi-stage workflow where stages of the multistage workflow are tracked by updating one or more entries of the delete request status table;
verify completion of the delete request by checking at least one entry in the delete request status table corresponding to the delete request;
attempt to write a corresponding entry to the notification table in response to a successful completion of the delete request; and
transmit, to at least one data consumer, a notification according to a result of both verifying completion of the delete request and attempting to write the corresponding entry to the notification table.

16. The system of claim 15, further comprising:
retrying one or more stages of the delete request a pre-selected number of times or until the write is successful; and
generating an indication of failure in response to the pre-selected number of unsuccessful attempts.

17. The system of claim 15, further comprising rolling back a data table in response to successful processing of the delete request and failure of the writing of the notification table entry.

18. The system of claim 15, further comprising,
managing multiple delete requests for multiple data tables that receive data from multiple disparate data sources concurrently; and
managing multiple corresponding notification tables.

19. The system of claim 15, further comprising modifying a version indicator for the notification table if the delete is successfully processed and the write attempt to the notification table is successfully completed.

20. The system of claim 15, further comprising analyzing a version indicator corresponding to the notification table to determine if changes have been made to the notification table that indicate changes to the data table.
